(19) United States
(12) Patent Application Publication
(10) Pub. No.: US 2026/0346650 A1
(43) Pub. Date: Nov. 5, 2026

(54) TIRE COMPRISING A FLEXIBLE TREAD

(71) Applicant: COMPAGNIE GENERALE DES ETABLISSEMENTS MICHELIN, Clermont-Ferrand (FR)

(72) Inventor: OLIVIER FRANCOIS, Clermont-Ferrand (FR)

(21) Appl. No.: 19/121,513

(22) PCT Filed: Sep. 19, 2023
(86) PCT No.: PCT/EP2023/075711

§ 371 Date: Apr. 16, 2025

(30) Foreign Application Priority Data
Oct. 18, 2022 (FR) FR2210732

(51) Int. Cl. B60C 11/11; B60C 11/03

(52) U.S. Cl. CPC B60C 11/11; B60C 11/0304; B60C 2011/0341; B60C 2011/0358

(57) ABSTRACT

A tire (10) comprises first, second and third circumferential grooves (62, 64, 66), transverse grooves (72) substantially parallel to one another and crossing each first, second and third circumferential groove (62, 64, 66), first, second and third circumferential columns (22, 24, 28) of blocks (20) and an additional circumferential column (30, 32) of blocks (20). The leading edge corner (202) of each block of each first, second and third circumferential column (22, 24, 28) forms an angle (D1, D2, D3) with the circumferential direction (X) strictly greater than the angle (A1, A2) formed by the mean direction of the leading edge corner (202) of each block of the additional circumferential column (30, 32).

The present invention relates to a tyre. A tyre is understood to be a casing intended to form a cavity by interacting with a support element, for example a rim, this cavity being able to be pressurized to a pressure higher than atmospheric pressure. A tyre according to the invention has a structure of substantially toroidal shape exhibiting symmetry of revolution about a main axis of the tyre.

The prior art discloses racing tyres intended for rally events, during which the vehicles fitted with such tyres run on rocky ground. Known tyres are MICHELIN LATITUDE CROSS® tyres.

For many years, rally events, also referred to as special stages, have been relatively lengthy. In order to obtain tyres that exhibit sufficient endurance to last throughout each special stage, preference is given to tyres that have relatively stiff treads. More recently, special stages have been made shorter, thus making the relatively high tread stiffness unnecessary.

An aim of the invention is to give the tyre better performance on special stages that require a less stiff tread.

To that end, the invention relates to a tyre having an inner side and an outer side that are imposed when the tyre is mounted on a vehicle, the tyre comprising a tread that comprises first and second axial edges arranged on the inner side and outer side, respectively, the tread comprising a plurality of blocks and a plurality of grooves comprising:
at least first, second and third circumferential grooves arranged such that there is at least a first, second and third substantially circumferential line passing through in each first, second and third circumferential groove, respectively, and extending continuously around a circumference of the tyre without intersecting any block of the plurality of blocks, each first, second and third substantially circumferential line having an axial width greater than or equal to 2 mm, each first, second and third circumferential groove being arranged in an axial portion of axial width equal to at most 75% of the axial width of the tread and extending from the first axial edge,
at least first, second and third circumferential columns of blocks of the plurality of blocks,
transverse grooves extending continuously from the first axial edge to the second axial edge of the tread substantially parallel to one another, each transverse groove crossing each first, second and third circumferential groove,
at least one additional circumferential column of blocks of the plurality of blocks, the or each additional circumferential column being the circumferential column, from among the first, second and third circumferential columns of blocks and said additional circumferential column, that is axially closest to the second axial edge, each block of the plurality of blocks comprising a leading edge corner, the leading edge corner of each block of at least each first, second and third circumferential column of blocks has a mean direction forming an angle with the circumferential direction of the tyre strictly greater than the angle formed with the circumferential direction of the tyre by the mean direction of the leading edge corner of each block of the or each additional circumferential column of blocks.

The presence of the first, second and third circumferential grooves in the axial portion of axial width equal to at most 75% of the axial width of the tread and extending from the first axial edge combined with the presence of the transverse grooves extending from the first axial edge to the second axial edge while crossing the first, second and third circumferential grooves makes it possible to ensure a relatively high flexibility of the tread in this axial portion, which is the portion most often in contact with the ground owing to the camber of motor vehicles. Specifically, these first, second and third circumferential grooves act as hinges that are oriented in the circumferential direction and enable an axial bending of the tread which better matches the profile of the ground on which the tyre is running. This improved adaptability of the tread makes it possible as a result to improve the performance of the tyre. The transverse grooves make it possible to provide the circumferential bending over the entire width of the tread and thus to better match the profile of the ground. By way of example, tests carried out on rocky ground between a vehicle fitted with the above-described tyres of the prior art and this same vehicle equipped with the tyres according to the invention have enabled a gain of one second per kilometre. Such a gain of time is considerable.

A substantially circumferential line is a line which, at any point on the line, forms an angle with the circumferential direction of the tyre of less than or equal to 5°.

The presence of the first, second and third circumferential columns of blocks makes it possible to effectively transmit forces along the circumferential direction owing to the orientation of the leading edge corner of each block of these circumferential columns. These blocks are essentially subjected to load when running in a straight line, for example during acceleration or braking, owing to the negative camber usually encountered on motor vehicles, notably motor racing vehicles, which causes greater loading of that portion of the tread that is on the inner side of the vehicle.

In addition, the orientation of the leading edge corner of each block of the additional circumferential column makes it possible to effectively transmit drift forces. Such drift forces are very frequently encountered in rally racing on rocky ground when cornering. Specifically, when cornering, the transfer of load associated with the kinematics of the running gear of the vehicle causes that portion of the tread that is on the outer side of the vehicle, and therefore the blocks of the additional circumferential column, to be subjected to greater loading. A circumferential column of blocks is understood to mean a column in which a translational movement along the circumferential direction causes a transfer from one block of the column to another, identical block of the column. Within one and the same circumferential column of blocks, it is possible to have a single type of block, i.e. two circumferentially consecutive blocks of the column are identical. It is also possible to have several different types of blocks, i.e. at least two identical blocks of a first type of the column are circumferentially separated by at least one block of a second type, which is different from the first type. Type is understood to mean the geometric shape of the block, for example its outer geometric shape or any sipes that may be formed therein.

The tyre according to the invention is a tyre having an inner side and an outer side that are imposed when it is mounted on the vehicle. This means that the tyre is designed such that one of its sides is arranged on the inner side and the other of its sides is arranged on the outer side. The expression “outer side” means the side of the tyre that is entirely visible from the outside of the vehicle when the tyre is mounted on the vehicle. The expression “inner side” means the side of the tyre that faces the wheel arch of the vehicle on which it is mounted. Generally, the tyre has a marking indicating the inner side and the outer side.

A block generally has several edge corners defining a contour of the block. These edge corners may be straight or curvilinear. A distinction is made between a leading edge corner, a trailing edge corner and lateral edge corners. The leading edge corner is the edge corner which comes into contact with the ground first when the tyre revolves in its direction of forwards rotation. The trailing edge corner is the edge corner which comes into contact with the ground last when the tyre revolves in its direction of forwards rotation. The lateral edge corners are the edge corners that connect the leading and trailing edge corners.

The angle between two directions is the angle which, in terms of absolute value, is the smaller of the two angles defined between a reference direction, most often the circumferential direction, of the tyre and the other direction.

The mean direction formed by an edge corner is the straight direction connecting the two ends of the edge corner.

In the case of a racing tyre, the axial width of the tread is determined on an unmounted and uninflated tyre by measuring the axial distance between the edge corners forming the first and second axial edges of the tread, these axial edges forming the delimitation between the tread and the sidewalls of the tyre. In the case of a racing tyre, each of these first and second axial edges comprise the lateral edge corners of the axially outermost blocks of the tread.

In the case of a tyre not intended for racing, it may be possible to determine the tread surface area on a tyre mounted on a measuring rim and inflated to its nominal pressure (250 kPa or 290 kPa depending on whether it is a standard or reinforced tyre) which, within the meaning of the ETRTO (“European Tyre and Rim Technical Organisation”) Standards Manual, 2021, is the surface area in contact with the ground when the tyre is loaded to 80% of its loading capacity within the meaning of the ETRTO Standards Manual, 2021, this load then representing the use conditions usually encountered. Another method may consist, on an unloaded tyre which is mounted on a measuring rim and inflated to the nominal pressure (250 kPa or 290 kPa depending on whether it is a standard or reinforced tyre) within the meaning of the ETRTO Standards Manual, 2021, in determining the axial limits of the tread surface, for example by considering that each axial limit of the tread surface passes through the point at which the angle between the tangent to the tread surface and a straight line parallel to the axial direction passing through this point is equal to 30°. When, in a meridian section plane, there are several points at which said angle is equal, in terms of absolute value, to 30°, the radially outermost point is used.

The invention particularly relates to racing tyres for motor vehicles. Racing is understood to mean officially timed events and not free running, sometimes referred to as “track days” or “HDPEs” (High Driving Performance Events), which covers events that are not officially timed.

The invention relates, very particularly and very preferably, to tyres for rally racing and more preferably for rally racing at least on rocky and/or gravelly and/or muddy ground and very preferably for rally racing on rocky ground.

The tyre according to the invention has a substantially toroidal shape about an axis of revolution substantially coincident with the axis of rotation of the tyre. This axis of revolution defines three directions conventionally used by those skilled in the art: an axial direction, a circumferential direction and a radial direction.

The tread surface of the tyre is the surface of the tread via which the tyre is made to come into contact with the ground when it runs on this ground.

The axial direction is understood to be the direction substantially parallel to the axis of revolution of the tyre, that is to say the axis of rotation of the tyre.

The circumferential direction is understood to be the direction that is substantially perpendicular both to the axial direction and to a radius of the tyre (in other words, tangent to a circle centred on the axis of rotation of the tyre).

The radial direction is understood to be the direction along a radius of the tyre, that is to say any direction that intersects the axis of rotation of the tyre and is substantially perpendicular to that axis.

The median plane of the tyre (denoted M) is understood to be the plane perpendicular to the axis of rotation of the tyre, which is located axially mid-way between the two beads and passes through the axial middle of the crown reinforcement.

The equatorial circumferential surface of the tyre is understood to be, in a meridian section plane, the surface passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and situated equidistantly between the radially outermost point of the tread that is intended to be in contact with the ground and the radially innermost point of the tyre that is intended to be in contact with a support, for example a rim.

The meridian plane is understood to be a plane that is parallel to and contains the axis of rotation of the tyre and is perpendicular to the circumferential direction.

“Radially inside” and “radially outside” mean “closer to the axis of rotation of the tyre” and “further away from the axis of rotation of the tyre”, respectively. “Axially inside” and “axially outside” mean “closer to the median plane of the tyre” and “further away from the median plane of the tyre”, respectively.

A bead is understood to be the radial portion of the tyre intended to allow the tyre to be attached to a mounting support, for example a wheel comprising a rim. As a result, each bead is notably intended to be in contact with a flange of the rim allowing it to be attached.

Any interval of values denoted by the expression “between a and b” represents the range of values ranging from more than a to less than b (that is to say, limits a and b excluded) whereas any interval of values denoted by the expression “from a to b” means the range of values ranging from a up to b (that is to say, including the strict limits a and b).

A cut denotes either a groove or a sipe and forms a space opening onto the tread surface.

A sipe or a groove has, on the tread surface, two main characteristic dimensions: a width and a curvilinear length such that the curvilinear length is at least equal to twice the width. A sipe or a groove is therefore delimited by at least two main lateral faces that determine its curvilinear length and are connected by a bottom face, the two main lateral faces being spaced apart from one another by a non-zero distance, referred to as the width of the cut.

On a new tyre, the width of a cut is the maximum distance between the two main lateral faces and measured, when the cut is not chamfered, at a radial dimension coincident with the tread surface and, when the cut is chamfered, at the radially outermost radial dimension of the cut and radially innermost dimension of the chamfer. The width is measured substantially perpendicularly to the main lateral faces.

A sipe is such that the distance between the main lateral faces is suitable for allowing the main lateral faces that delimit said sipe to come into at least partial contact when passing through the contact patch, in particular when the tyre is new.

A groove is such that the distance between the main lateral faces is such that these main lateral faces cannot come into contact with one another, notably when the tyre is new.

A cut may be transverse or circumferential.

A transverse cut is such that the cut extends in a mean direction that forms an angle with the circumferential direction of the tyre strictly greater than 30°, preferably greater than or equal to 45°. The mean direction is the shortest curve that joins the two ends of the cut and is parallel to the tread surface. A transverse cut may be continuous, i.e. not interrupted by a block or another cut, such that the two main lateral faces determining its length are uninterrupted along the length of the transverse cut. A transverse cut may also be discontinuous, i.e. interrupted by one or more blocks and/or one or more cuts, such that the two main lateral faces determining its length are interrupted by one or more blocks and/or one or more cuts.

A circumferential cut is such that the cut extends in a mean direction that forms an angle with the circumferential direction of the tyre less than or equal to 30°, preferably less than or equal to 10°. The mean direction is the shortest curve that joins the two ends of the cut and is parallel to the tread surface. In the case of a continuous circumferential cut, the two ends coincide with each other and are joined by a curve that makes a full circuit around the tyre. A circumferential cut may be continuous, i.e. not interrupted by a block or another cut, such that the two main lateral faces determining its length are uninterrupted over a full circuit around the tyre. A circumferential cut may also be discontinuous, i.e. interrupted by one or more blocks and/or one or more cuts, such that the two main lateral faces determining its length are interrupted by one or more blocks and/or one or more cuts over a full circuit around the tyre.

In some embodiments, the or each circumferential cut is chamfered. A chamfer of a circumferential cut may be a straight chamfer or a rounded chamfer. A straight chamfer is formed by a planar face that is inclined with respect to the axially inner and outer face that it extends as far as the axially inner or outer edge axially delimiting the circumferential cut. A rounded chamfer is formed by a curved face that merges tangentially into the axially inner or outer face that it extends. A chamfer of a circumferential cut is characterized by a height and a width that are equal to the radial distance and to the axial distance, respectively, between the common point shared by the axially inner or outer face extended by the chamfer, and the axially inner or outer edge that axially delimits the circumferential cut.

In some embodiments, the or each transverse cut is chamfered. In other words, each transverse cut is radially delimited by faces that circumferentially delimit said transverse cut and are connected to one another by a bottom face that delimits said transverse cut radially inwards. A chamfer of a transverse cut may be a straight chamfer or a rounded chamfer. A straight chamfer is formed by a planar face that is inclined with respect to the face that it extends as far as the edge that circumferentially delimits the transverse cut. A rounded chamfer is formed by a curved face that merges tangentially into the face that it extends. A chamfer of a transverse cut is characterized by a height and a width that are equal to the radial distance and to the axial distance, respectively, in a direction perpendicular to the faces between the common point shared by the face extended by the chamfer, and the edge that circumferentially delimits the transverse cut.

On a new tyre, the depth of a cut is the maximum radial distance between the bottom of the cut and its projection onto the ground when the tyre is running. The maximum value for the depths of the cuts is referred to as the tread pattern height.

In preferred embodiments, each first, second and third substantially circumferential line has an axial width greater than or equal to 5 mm and more preferably greater than or equal to 7 mm. This promotes the hinge effect of the first, second and third circumferential grooves.

In preferred embodiments utilizing an optimum positioning of the first, second and third circumferential grooves to improve the adaptability of the tyre tread, notably when running in a straight line, each first, second and third circumferential groove is arranged in an axial portion of axial width equal to at most 70% of the axial width of the tread and extending from the first axial edge.

In advantageous but optional embodiments, the leading edge corner of each block of at least each first, second and third circumferential column of blocks has a mean direction forming an angle with the circumferential direction of the tyre greater than or equal to 50°, preferably 60°.

As a result, by modifying the angle formed by the leading edge corner and the circumferential direction of each block of the first, second and third circumferential columns, and in this case by increasing it, it is possible to optimize the position of the leading edge corner so as to position it as perpendicularly as possible relative to the overall direction of the forces when running in a straight line, thereby enabling improved transmission of the forces and therefore increased traction.

In advantageous but optional embodiments, the leading edge corner of each block of the or each additional circumferential column of blocks has a mean direction forming an angle with the circumferential direction of the tyre less than or equal to 60°, preferably 50°.

As a result, by modifying the angle formed by the leading edge corner and the circumferential direction of each block of the or each additional circumferential column, and in this case by decreasing it, it is possible to optimize the position of the leading edge corner so as to position it as perpendicularly as possible relative to the overall direction of the cornering forces, thereby enabling improved transmission of the forces and therefore increased traction.

Advantageously, the first circumferential groove is the circumferential groove from among the first, second and third circumferential grooves that is axially closest to the first axial edge, the third circumferential groove is the circumferential groove from among the first, second and third circumferential grooves that is axially closest to the second axial edge, and the second circumferential groove is axially between the first circumferential groove and the third circumferential groove.

In preferred embodiments utilizing an optimum positioning of the first, second and third circumferential grooves to improve the adaptability of the tread of the tyre:
the first circumferential groove is arranged axially in a first axial portion extending axially between axial limits at 3% and 25%, preferably at 5% and 20%, of the axial width of the tread from the first axial edge, and/or
the second circumferential groove is arranged axially in a second axial portion extending axially between axial limits at 19% and 42%, preferably at 23% and 39%, of the axial width of the tread from the first axial edge, and/or
the third circumferential groove is arranged axially in a third axial portion extending axially between axial limits at 42% and 70%, preferably at 46% and 66%, of the axial width of the tread from the first axial edge.

Advantageously, the first circumferential column of blocks is the column of blocks from among the first, second and third circumferential columns of blocks that is axially closest to the first axial edge, the third circumferential column of blocks is the column of blocks from among the first, second and third circumferential columns of blocks that is axially closest to the second axial edge, and the second circumferential column of blocks is axially between the first circumferential column and the third circumferential column.

In some embodiments:
each block of the first circumferential column is delimited axially by the first circumferential groove and the first axial edge,
each block of the second circumferential column being delimited axially by the first and second circumferential grooves,
each block of the third circumferential column being delimited axially at least partially by the third circumferential groove.

In advantageous but optional embodiments, with each transverse groove extending axially in an axially variable main direction, the angle formed by the main direction of each transverse groove and the circumferential direction of the tyre:
exhibits a non-zero monotonous variation between the first and second axial edges of the tread, or
is constant over at least one axial portion between the first and second axial edges of the tread and exhibits a non-zero monotonous variation over at least one additional axial portion between the first and second axial edges of the tread.

The expression “axially variable direction” is understood to mean that the main direction of each transverse groove varies axially along each transverse groove.

The additional portions are such that, considered together, the additional portions extend integrally from the first axial edge to the second axial edge of the tread.

A constant angle corresponds to zero variation of the angle.

The expression “non-zero monotonous variation” is understood to mean that the angle solely increases or solely decreases between the first and second axial edges of the tread.

As a result, since each transverse groove delimits the leading edge corners of the blocks of the various columns of blocks, the non-zero monotonous variation makes it possible to obtain a variation in traction as a function of the angle of rotation of the tyre about the axis of the running gear and thus to enable continuous traction between running in a straight line and cornering.

More preferably, the angle formed by the main direction of each transverse groove and the circumferential direction of the tyre at the first axial edge is greater than the angle formed by the main direction of each transverse groove and the circumferential direction of the tyre at the second axial edge. As a result, in the case of a non-zero monotonous variation, the angle solely decreases from the first axial edge to the second axial edge of the tread or over the corresponding portion between the first axial edge and the second axial edge of the tread.

In preferred embodiments, the angle formed with the circumferential direction by the mean direction of the leading edge corner of each block of at least one given circumferential column of blocks is strictly greater than the angle formed with the circumferential direction by the mean direction of the leading edge corner of each block of the circumferential column of blocks that is axially adjacent thereto, the axially adjacent column being closer to the second axial edge than the given circumferential column of blocks. More preferably, for at least 50% of the pairs of mutually axially adjacent circumferential columns of blocks, even more preferably for at least 75% of the pairs of mutually axially adjacent circumferential columns of blocks, and in this case for each pair of mutually axially adjacent circumferential columns of blocks, the angle formed with the circumferential direction by the mean direction of the leading edge corner of each block of a first one of the circumferential columns of blocks of the pair is strictly greater than the angle formed with the circumferential direction by the mean direction of the leading edge corner of each block of the second circumferential column of blocks of the pair, the second circumferential column of blocks of each pair being the column from among the first and second circumferential columns of blocks of said pair that is closest to the second axial edge.

In preferred embodiments, the angle formed by the main direction of each transverse groove and the circumferential direction of the tyre at the first axial edge ranges between 70° and 90° and the angle formed by the main direction of each transverse groove and the circumferential direction of the tyre at the second axial edge ranges between 30° and 60°.

In preferred embodiments, the angle formed with the circumferential direction by the mean direction of the leading edge corner of each block of the first circumferential column is greater than or equal to the angle formed with the circumferential direction by the mean direction of the leading edge corner of each block of the second circumferential column, which is strictly greater than the angle formed with the circumferential direction by the mean direction of the leading edge corner of each block of the third circumferential column.

As a result, since each transverse groove delimits the leading edge corners of the blocks of the various columns of blocks, an excellent traction when running in a straight line is afforded owing to the relatively large angle between the leading edge corners of the blocks that are in the vicinity of the first edge, corresponding to the inner side which is subjected to loading when running in a straight line, and the circumferential direction. An excellent traction when cornering is also afforded owing to the relatively small angle between the leading edge corners of the blocks that are in the vicinity of the second edge, corresponding to the outer side which is subjected to loading when cornering, and the circumferential direction.

With preference, the leading edge corner of each block of each first and second circumferential column has a mean direction forming an angle with the circumferential direction that ranges from 70° to 90°. With preference, the leading edge corner of each block of the third circumferential column has a mean direction forming an angle with the circumferential direction that ranges from 50° to 70°. With preference, the leading edge corner of each block of the or each additional circumferential column has a mean direction forming an angle with the circumferential direction that ranges from 30° to 60°.

In advantageous but optional embodiments, the tread comprises a fourth circumferential column of blocks of the plurality of blocks that is axially between the second and the third circumferential column of blocks, the leading edge corner of each block of the fourth circumferential column of blocks having a mean direction which forms an angle strictly greater than the angle formed by the mean direction of the leading edge corner of each block of the or each additional circumferential column of blocks.

In advantageous but optional embodiments, the angle formed with the circumferential direction by the mean direction of the leading edge corner of each block of the fourth circumferential column is strictly greater than the angle formed with the circumferential direction by the mean direction of the leading edge corner of each block of the third circumferential column.

With preference, the leading edge corner of each block of the fourth circumferential column has a mean direction forming an angle with the circumferential direction that ranges from 65° to 85°.

With preference, each block of the fourth circumferential column is delimited axially by the second and third circumferential grooves.

In yet other embodiments, it would be possible to envisage that the tread comprises a fifth or even a sixth circumferential column of blocks of the plurality of blocks that is (are) axially between the second and the third circumferential column of blocks, the blocks of this fifth or of these fifth and sixth columns the leading edge corner of each of this fifth circumferential column of blocks or of these fifth and sixth circumferential columns of blocks having a mean direction which forms an angle strictly greater than the angle formed by the mean direction of the leading edge corner of each block of the or each additional circumferential column of blocks.

In advantageous but optional embodiments, each block of the or each additional circumferential column of blocks is delimited by at least one oblique groove which crosses at least two circumferentially consecutive transverse grooves and is arranged such that there is no circumferential line extending continuously around a circumference of the tyre and passing through the or each oblique groove delimiting each block of said additional circumferential column of blocks without intersecting the blocks of said additional circumferential column of blocks.

As a result, each oblique groove does not form a hinge, by contrast with the first, second and third circumferential grooves.

Two circumferentially consecutive transverse grooves are such that no other transverse groove is circumferentially between said two circumferentially consecutive transverse grooves.

Optionally, the tread comprises first and second additional circumferential columns of blocks of the plurality of blocks, each first and second additional circumferential column being axially closer to the second axial edge than the first, second and third circumferential columns of blocks,
the leading edge corner of each block of at least each first, second and third circumferential column of blocks has a mean direction forming an angle strictly greater than the angle formed by the mean direction of the leading edge corner of each block of each first and second additional circumferential column of blocks,
each block of the first additional circumferential column of blocks being axially delimited by two oblique grooves crossing two circumferentially consecutive transverse grooves,
each block of the second additional circumferential column of blocks being axially delimited by an oblique groove crossing two circumferentially consecutive transverse grooves and the second axial edge,
each block of each first and second additional circumferential column of blocks being arranged such that there is no circumferential line extending continuously around a circumference of the tyre and passing through the or each oblique groove delimiting each block of each first and second additional circumferential column of blocks without intersecting the blocks of each first and second additional circumferential column of blocks, respectively.

In advantageous but optional embodiments, with the second additional circumferential column being arranged axially on the outside of the first additional circumferential column, the angle formed with the circumferential direction by the mean direction of the leading edge corner of each block of the first additional circumferential column is strictly greater than the angle formed with the circumferential direction by the mean direction of the leading edge corner of each block of the second additional circumferential column.

In advantageous but optional embodiments, the leading edge corner of each block of each first and second additional circumferential column of blocks has a mean direction forming an angle with the circumferential direction of the tyre less than or equal to 60°, preferably 50°.

As already indicated, by modifying the angle formed by the leading edge corner and the circumferential direction, and in this case by decreasing it, the transmission of forces is improved and traction is thus amplified.

In advantageous but optional embodiments, each first and second circumferential column of blocks comprises a single block between two circumferentially consecutive transverse grooves.

The presence of a single block between two circumferentially consecutive transverse grooves makes it possible to give the blocks of each first and second circumferential column of blocks a relatively great length in the circumferential direction and therefore to limit any chunking of these blocks, which are subjected to high loading when running in a straight line, especially during acceleration and braking phases.

In advantageous but optional embodiments, the third circumferential column of blocks comprises at least two blocks, preferably only two blocks, between two circumferentially consecutive transverse grooves.

Since the blocks of the third circumferential column of blocks are even further away from the inner side than those of each first and second circumferential column of blocks, the blocks of the third circumferential column of blocks are subjected to less loading than those of each first and second circumferential column of blocks and thus less sensitive to possible chunking. As a result, it is possible to reduce their length in the circumferential direction and thus to maximize the number of leading edge corners that come into contact with the ground by increasing the number of them between two circumferentially consecutive transverse grooves.

With preference, the leading edge corner of at least one portion of the blocks of the third circumferential column of blocks, preferably of at least 50% of the blocks of the third circumferential column of blocks and more preferably of at least 75% of the blocks of the third circumferential column of blocks, has a curvilinear length strictly greater than the curvilinear length of each lateral edge corner of said block.

The greater the curvilinear length of the leading edge corner, the better the traction and braking performance.

In embodiments in which the tread comprises a fourth circumferential column of blocks which is axially between the second and the third circumferential column of blocks, the fourth circumferential column of blocks comprises at least two blocks, preferably only two blocks, between two circumferentially consecutive transverse grooves.

With preference, the leading edge corner of at least one portion of the blocks of the fourth circumferential column of blocks, preferably of at least 50% of the blocks of the fourth circumferential column of blocks and more preferably of at least 75% of the blocks of the fourth circumferential column of blocks, has a curvilinear length strictly greater than the curvilinear length of each lateral edge corner of said block.

Here, too, the multiplication of the blocks between two circumferentially consecutive transverse grooves and the maximization of the curvilinear length of the leading edge corners of the blocks makes it possible to provide good traction and braking performance.

With preference, the additional circumferential column of blocks comprises a single block between two circumferentially consecutive transverse grooves.

If the tread comprises first and second additional circumferential columns of blocks, each first and second additional circumferential column of blocks comprises a single block between two circumferentially consecutive transverse grooves.

Analogously to the first and second circumferential columns of blocks, the presence of a single block between two circumferentially consecutive transverse grooves makes it possible to give the blocks of each first and second additional circumferential column of blocks a relatively great length in the circumferential direction and therefore to limit any chunking of these blocks, which are subjected to high loading when cornering.

In embodiments that are particularly suitable for racing tyres, notably tyres for rally racing, the width of each circumferential groove is greater than or equal to 2 mm, preferably ranges from 5 mm to 15 mm and more preferably ranges from 7 mm to 12 mm.

Still in embodiments that are particularly suitable for racing tyres, notably tyres for rally racing, the width of each oblique groove is greater than or equal to 2 mm, preferably ranges from 5 mm to 15 mm and more preferably ranges from 7 mm to 12 mm.

Still in embodiments that are particularly suitable for racing tyres, notably tyres for rally racing, the width of each transverse groove is greater than or equal to 2 mm, preferably ranges from 5 mm to 15 mm and more preferably ranges from 7 mm to 12 mm.

Still in embodiments that are particularly suitable for racing tyres, notably tyres for rally racing, the tread pattern height is greater than or equal to 7 mm, and preferably ranges from 9 mm to 16 mm.

Still in embodiments that are particularly suitable for racing tyres, notably tyres for rally racing, the void ratio by area of the tread that is associated with the grooves having a width greater than or equal to 2 mm, preferably 4 mm, ranges from 35% to 55%, preferably from 40% to 50%.

Still in embodiments that are particularly suitable for racing tyres, notably tyres for rally racing, the void ratio by volume of the tread that is associated with the grooves having a width greater than or equal to 2 mm, preferably 4 mm, ranges from 30% to 45%, preferably from 35% to 45%.

The void ratio by area that is associated with grooves is the ratio of:
the difference between the imaginary total area AT of the tread without said grooves and the ground-contact area AC of the blocks of the tread, and
the imaginary total area AT of the contact patch of the tread without said grooves.

The ground-contact area of the blocks is measured on a new tyre. For example, it would be possible to manually measure the individual surface of the blocks. It would also be possible to make the new tyre, unmounted and uninflated, run on a smooth ground, for example a pane of glass, and optically measure the individual surface of each block to deduce the ground-contact area therefrom.

The void ratio by volume that is associated with grooves is the ratio of the total volume of said grooves of the new tyre, unmounted and uninflated, to the total volume of the tread when new but without comprising any of said grooves. In order to measure such a void ratio by volume, it would notably be possible to use one of the methods described in WO2021/089958.

The features indicated above characterize the tyre when it is new.

The invention also relates to a pair of a first and a second tyre, each first and second tyre being as defined above, in which pair the tread of the first tyre is symmetrical to the tread of the second tyre with respect to a plane of symmetry substantially perpendicular to an axis of rotation common to the first and second tyres.

The invention also relates to the use of a tyre having an inner side and an outer side that are imposed when the tyre is mounted on a vehicle, the tyre comprising a tread that comprises first and second axial edges arranged on the inner side and outer side, respectively, the tread comprising a plurality of blocks and a plurality of grooves comprising:
at least first, second and third circumferential grooves arranged such that there is at least a first, second and third substantially circumferential line passing through in each first, second and third circumferential groove, respectively, and extending continuously around a circumference of the tyre without intersecting any block of the plurality of blocks, each first, second and third substantially circumferential line having an axial width greater than or equal to 2 mm, each first, second and third circumferential groove being arranged in an axial portion of axial width equal to at most 75% of the axial width of the tread and extending from the first axial edge,
at least first, second and third circumferential columns of blocks of the plurality of blocks,
transverse grooves extending continuously from the first axial edge to the second axial edge of the tread substantially parallel to one another, each transverse groove crossing each first, second and third circumferential groove,
at least one additional circumferential column of blocks of the plurality of blocks, the or each additional circumferential column being the circumferential column, from among the first, second and third circumferential columns of blocks and said additional circumferential column, that is axially closest to the second axial edge,
each block of the plurality of blocks comprising a leading edge corner, the leading edge corner of each block of at least each first, second and third circumferential column of blocks has a mean direction forming an angle with the circumferential direction of the tyre strictly greater than the angle formed with the circumferential direction of the tyre by the mean direction of the leading edge corner of each block of the or each additional circumferential column of blocks, or of a pair of a first and a second tyre as defined above, in racing, preferably in rally racing and more preferably in rally racing at least on rocky and/or gravelly and/or muddy ground and very preferably in rally racing on rocky ground.

The invention will be better understood on reading the following description, which is given solely by way of non-limiting example and with reference to the drawings, in which:

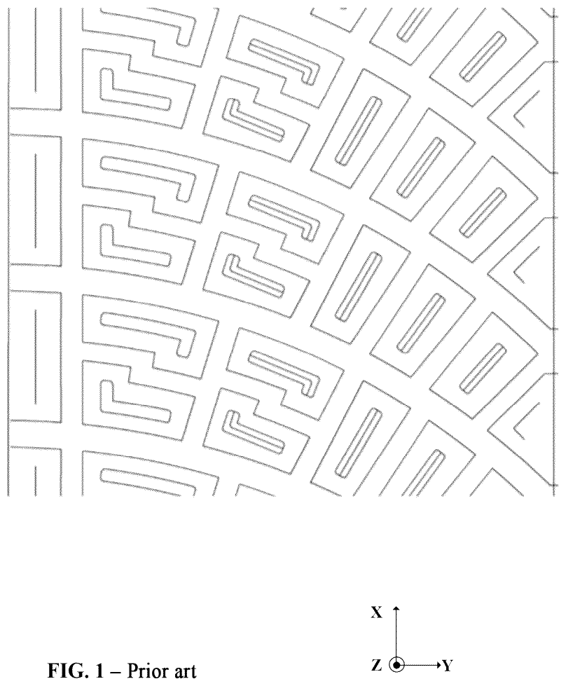

FIG. 1 is a schematic top view of a tread of the prior-art tyre, MICHELIN LATITUDE CROSS®,

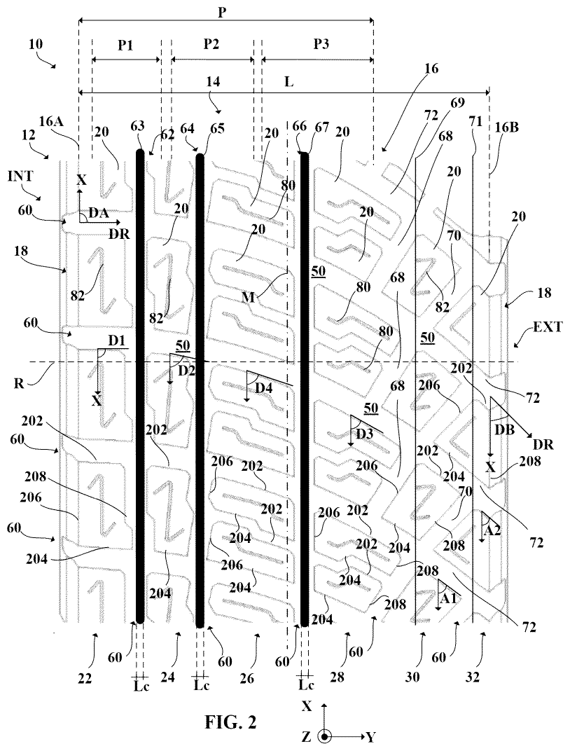

FIG. 2 is a top view of a tyre according to the invention,

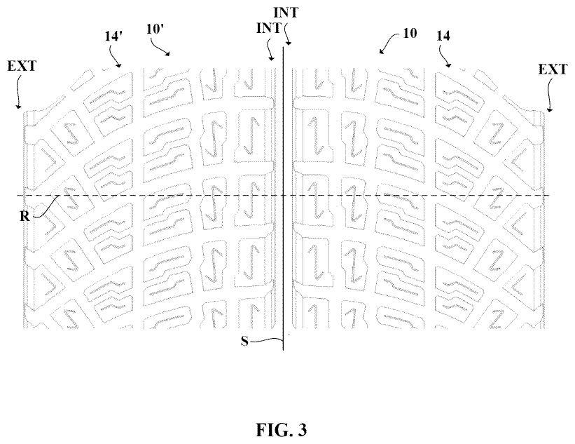

FIG. 3 is a top view of a pair of a first and a second tyre according to the invention,

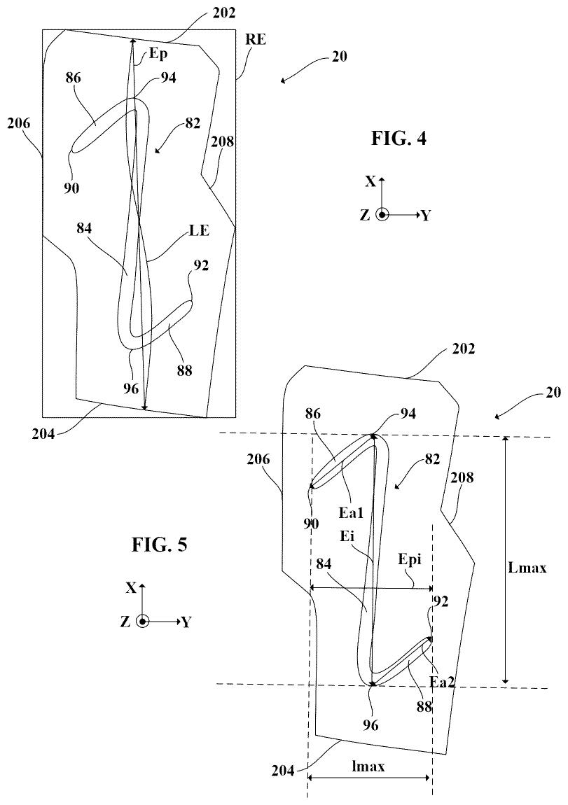

FIGS. 4 to 8 are detail views of one and the same block of the tread of the tyre in FIG. 2, and

FIGS. 9 to 12 are detail views of blocks according to various embodiments.

A frame of reference X, Y, Z corresponding to the usual axial (Y), radial (Z) and circumferential (X) directions, respectively, of a tyre is shown in the figures.

FIG. 2 shows a tyre according to the invention and denoted by the overall reference 10. The tyre 10 has a substantially toroidal shape about an axis of revolution R substantially parallel to the axial direction Y. The tyre 10 is of size 17/65 R15 and is intended for use in racing, in this case in rally racing and more preferably in rally racing at least on rocky and/or gravelly and/or muddy ground and very preferably in rally racing on rocky ground. The magnitude “17” relates to the theoretical width of the tread, which in this case is 17 cm, the magnitude 65 relates to the theoretical diameter of the tyre, which in this case is 65 cm, and the magnitude “R15” characterizes a radial tyre designed to be mounted on a 15 inch rim. In the various figures, the tyre 10 is shown as new, i.e., when it has not yet been run.

The tyre 10 comprises a crown 12 comprising a tread 14 intended to come into contact with the ground via a tread surface 16 when the tyre is running. The tread 14 comprises and is delimited by first and second axial edges 16A and 16B defining an axial width L of the tread surface 16. In this case, L=178 mm. The tyre 10 has an inner side INT and an outer side EXT which are imposed when the tyre 10 is mounted on a vehicle. The first axial edge 16A is arranged on the inner side INT and the second axial edge 16B is arranged on the outer side EXT.

The tyre 10 comprises two sidewalls 18 that extend the crown 12 radially inwards. The tyre 10 also comprises two beads (not illustrated) radially on the inside of the sidewalls 18 and intended to allow the tyre 10 to be attached to a mounting support, for example a rim. Each sidewall 18 connects each bead to the crown 12.

The tread 14 comprises a plurality of blocks 20 and a plurality of cuts 50 delimiting the plurality of blocks 20. The plurality of cuts 50 comprises a plurality of grooves 60 and a plurality of sipes 80.

The plurality of grooves 60 comprises first, second and third circumferential grooves 62, 64, 66 arranged such that there is at least a first, second and third substantially circumferential line 63, 65, 67 passing through in each first, second and third circumferential groove 62, 64, 66, respectively, and extending continuously around a circumference of the tyre without intersecting any block of the plurality of blocks 20. Each first, second and third substantially circumferential line 63, 65, 67 has an axial width Lc greater than or equal to 2 mm, preferably greater than or equal to 5 mm and in this case greater than or equal to 7 mm.

The first circumferential groove 62 is the circumferential groove from among the first, second and third circumferential grooves 62, 64, 66 that is axially closest to the first axial edge 16A. The third circumferential groove 66 is the circumferential groove from among the first, second and third circumferential grooves 62, 64, 66 that is axially closest to the second axial edge 16B. The second circumferential groove 64 is axially between the first circumferential groove 62 and the third circumferential groove 66.

Each first, second and third circumferential groove 62, 64, 66 is arranged in an axial portion of axial width P equal to at most 75%, preferably at most 70%, of the axial width L of the tread 14 and extending from the first axial edge 16A.

More specifically, the first circumferential groove 62 is arranged axially in a first axial portion P1 extending axially between axial limits at 3% and 25%, preferably at 5% and 20%, of the axial width L of the tread 14 from the first axial edge 16A. The second circumferential groove 64 is arranged axially in a second axial portion P2 extending axially between axial limits at 19% and 42%, preferably at 23% and 39%, of the axial width L of the tread 14 from the first axial edge 16A. The third circumferential groove 66 is arranged axially in a third axial portion P3 extending axially between axial limits at 42% and 70%, preferably at 46% and 66%, of the axial width L of the tread 14 from the first axial edge 16A.

The plurality of grooves 60 also comprises transverse grooves 72 extending continuously from the first axial edge 16A to the second axial edge 16B of the tread 14. The transverse grooves 72 extend substantially parallel to one another. Each transverse groove 72 extends axially in an axially variable main direction. Each transverse groove 72 crosses each first, second and third circumferential groove 62, 64, 66.

The angle formed by the main direction of each transverse groove 72 and the circumferential direction X is constant over an axial portion extending axially from the first axial edge 16A and the first circumferential line 63 and exhibits a non-zero monotonous variation, which in this case strictly decreases, over an additional axial portion extending axially from the first circumferential line 63 and the second axial edge 16B. In addition, the angle DA formed by the main direction DR of each transverse groove 72 and the circumferential direction X of the tyre at the first axial edge 16A is greater than the angle DB formed by the main direction DR of each transverse groove 72 and the circumferential direction X at the second axial edge 16B. The angle DA ranges between 70° and 90° and in this case is substantially equal to 90°. The angle DB ranges between 30° and 60° and in this case is substantially equal to 50°.

The plurality of blocks 20 comprises first, second, third and fourth circumferential columns of blocks 20 of the plurality of blocks 20, denoted by the references 22, 24, 28, 26, respectively, and first and second additional circumferential columns 30, 32 of blocks 20 of the plurality of blocks 20. The first and second additional circumferential columns 30, 32 of blocks 20 are separate from the first, second, third and fourth circumferential columns 22, 24, 28, 26 of blocks 20. Each additional circumferential column 30, 32 is axially closer to the second axial edge than the first, second and third circumferential columns 22, 24, 28, 26. The first circumferential column 22 of blocks 20 is the column of blocks from among the first, second and third circumferential columns 22, 24, 26 of blocks that is axially closest to the first axial edge 16A. The third circumferential column 28 is the column of blocks from among the first, second, third and fourth circumferential columns 22, 24, 28, 26 of blocks that is axially closest to the second axial edge 16B. The second circumferential column 24 is axially between the first circumferential column 22 and the third circumferential column 28. The fourth circumferential column 26 is axially between the second circumferential column 24 and the third circumferential column 28.

Each block 20 of the first circumferential column 22 is delimited axially by the first circumferential groove 62 and the first axial edge 16A. Each block 20 of the second circumferential column 24 is delimited axially by the first and second circumferential grooves 62, 64. Each block 20 of the third circumferential column 28 is delimited axially at least partially by the third circumferential column 66. Each block 20 of the fourth circumferential column 26 is delimited axially by the second and third circumferential grooves 64, 66.

Each first and second circumferential column 22, 24 comprises a single block 20 between two circumferentially consecutive transverse grooves 72. Each third and fourth circumferential column 28, 26 comprises at least two blocks 20, preferably only two blocks 20, between two circumferentially consecutive transverse grooves 72.

Each first and second additional circumferential column 30, 32 of blocks 20 is axially on the outside of the third circumferential column 28. The second additional circumferential column 32 is axially on the outside of the first additional circumferential column 30.

Each block 20 of the first additional circumferential column 30 is axially delimited by two oblique grooves 68, 70 crossing two circumferentially consecutive transverse grooves 72. Each block 20 of the second additional circumferential column 32 is axially delimited by an oblique groove 70 crossing two circumferentially consecutive transverse grooves 72 and the second axial edge 16B.

FIG. 2 shows two circumferential lines 69, 71 passing through each oblique groove 68, 70. Each of these circumferential lines 69, 71 necessarily intersects the blocks 20 of each first and second additional circumferential column 30, 32, respectively. As a result, more generally, each block 20 of each first and second additional circumferential column 30, 32 is arranged such that there is no substantially circumferential line extending continuously around a circumference of the tyre and passing through each oblique groove 68, 70 delimiting each block of each first and second additional circumferential column 30, 32 without intersecting the blocks 20 of each first and second additional circumferential column 30, 32, respectively.

Each first and second additional circumferential column 30, 32 comprises a single block 20 between two circumferentially consecutive transverse grooves 72.

Each block 20 of the plurality of blocks 20 comprises several edge corners defining an in this case substantially polygonal contour. Each block 20 of each first, second, third and fourth circumferential column 22, 24, 28, 26 and of each first and second additional circumferential column 30, 32 comprises a leading edge corner 202, a trailing edge corner 204 and lateral edge corners 206, 208.

The leading edge corner 202 of each block 20 of each first, second, third and fourth circumferential column 22, 24, 28, 26 has a mean direction respectively forming an angle D1, D2, D3, D4 with the circumferential direction X strictly greater than the angle A1, A2 formed with the circumferential direction X by the mean direction of the leading edge corner 202 of each block 20 of each first and second additional circumferential column 30, 32, respectively.

The angle D1, D2, D4, D3, A1, A2 formed with the circumferential direction X by the mean direction of the leading edge corner 202 of each block 20 of each circumferential column 22, 24, 26, 28, 30, 32 is strictly greater than the angle D2, D4, D3, A1, A2 formed with the circumferential direction X by the mean direction of the leading edge corner 202 of each block 20 of the circumferential column 24, 26, 28, 30, 32 that is axially adjacent thereto, each column 24, 26, 28, 30, 32 axially adjacent to a given circumferential column 22, 24, 26, 28, 30, 32 being closer to the outer side EXT than each corresponding given circumferential column 22, 24, 26, 28, 30, 32.

The leading edge corner 202 of 100% of the blocks 20 of each third and fourth circumferential column 28, 26 has a curvilinear length strictly greater than the curvilinear length of each lateral edge corner 206, 208 of said block 20.

Each angle D1, D2, D3, D4 is greater than or equal to 50°, preferably greater than or equal to 60°. The angle D1 is greater than or equal to the angle D2. The angle D2 is strictly greater than the angle D3. The angle D4 is strictly greater than the angle D3. In this particular instance, each angle D1, D2 ranges from 70° to 90°, the angle D3 ranges from 50° to 70°, and the angle D4 ranges from 65° to 85°. D1=90°, D2=85°, D3=60° and D4=75°.

Each angle A1, A2 is less than or equal to 60°, preferably less than or equal to 50°. The angle A1 is strictly greater than the angle A2. In this particular instance, each angle A1, A2 ranges from 30° to 60°. A1=45° and A2=40°.

The width of each first, second and third circumferential groove 62, 64, 66 is greater than or equal to 2 mm, preferably ranges from 5 mm to 15 mm and more preferably ranges from 7 mm to 12 mm, and in this case is equal to 9.7 mm, 8.7 mm and 9.7 mm, respectively. The width of each transverse groove 72 is greater than or equal to 2 mm, preferably ranges from 5 mm to 15 mm and more preferably ranges from 7 mm to 12 mm, and in this case is equal to 9.6 mm. The width of each oblique groove 68, 70 is greater than or equal to 2 mm, preferably ranges from 5 mm to 15 mm and more preferably ranges from 7 mm to 12 mm, and in this case is equal to 10 mm.

The void ratio by area of the tread 14 that is associated with the grooves having a width greater than or equal to 2 mm, preferably 4 mm, in this case associated with the circumferential grooves 62, 64, 66, with the transverse grooves 72 and with the oblique grooves 68, 70 ranges from 35% to 55%, preferably from 40% to 50%, and in this case is equal to 44%. The void ratio by volume of the tread that is associated with the grooves having a width greater than or equal to 2 mm, preferably 4 mm, in this case associated with the circumferential grooves 62, 64, 66, with the transverse grooves 72 and with the oblique grooves 68, 70 ranges from 30% to 45%, preferably from 35% to 45%, and in this case is equal to 39%.

The tread pattern height is greater than or equal to 7 mm, preferably ranges from 9 mm to 16 mm, and in this case is equal to 12 mm.

With reference to FIG. 3, a pair 100 of a first and a second tyre 10, 10′, both in accordance with the invention, is shown. The tread 14 of the first tyre 10 is symmetrical to the tread 14′ of the second tyre 10′ with respect to a plane of symmetry S substantially perpendicular to an axis of rotation R common to the first and second tyres 10, 10′. In the example in FIG. 3, the first tyre 10 is intended to be mounted on the right-hand side of a vehicle whereas the second tyre 10′ is intended to be mounted on the left-hand side of a vehicle such that the inner side INT of each first and second tyre 10, 10′ faces the wheel arch of the vehicle and such that the side EXT of each first and second tyre 10, 10′ is entirely visible from the outside of the vehicle when the tyre is mounted on the vehicle.

With reference to FIG. 2, each block 20 of the tread 14 comprises a single sipe 80. Each block 20 of each first and second circumferential column 22, 24 and of the additional circumferential column 30 comprises a sipe 82 referred to as elongate sipe, and in this case a single elongate sipe 82.

A detailed description will now be given with reference to FIGS. 4 and 5 of a block 20 of the second circumferential column 24 of blocks and the elongate sipe 82 formed therein.

With reference to FIG. 4, each block 20 of the second circumferential column 24 is long in the circumferential direction X. Specifically, each block 20 of the second circumferential column 24 is inscribed in a rectangle RE of which two sides are parallel to the axial direction Y and of which two other sides are parallel to the circumferential direction X. Since the two sides that are parallel to the axial direction Y are smaller than the two sides that are parallel to the circumferential direction X, each block 20 of the second circumferential column 24 is long in the circumferential direction X. The line of slenderness LE of each block 20 of the second circumferential column 24 is the curved line that joins the two edge corners, leading 202 and trailing 204, and is equidistant from the lateral edge corners 206, 208 joining the leading edge corner 202 and trailing edge corner 204. The mean direction of slenderness Ep is the straight line that passes through the intersection points between the curved line of slenderness and the two edge corners, leading 202 and trailing 204, that it crosses.

The circumferential length of each block 20 of the second circumferential column 24, i.e. in this case the length of the two sides of the rectangle RE that are parallel to the circumferential direction X, is equal to 40 mm. The width of each block 20 of the second circumferential column 24, i.e. in this case the length of the two sides of the rectangle RE that are parallel to the axial direction Y, is equal to 22 mm.

Each elongate sipe 82 has a depth greater than or equal to 9 mm, preferably ranging from 10 to 14 mm and in this case equal to 12 mm. This depth is greater than or equal to 50%, preferably 70% and more preferably 90% of the height of the block 20 in which said elongate sipe 82 is formed. In this case, the height of each block 20 of the second circumferential column 24 is substantially equal to 12 mm. Each elongate sipe 82 has a width less than or equal to 2.0 mm, preferably ranging from 0.5 mm to 2.0 mm and in this case equal to 1.0 mm.

Each elongate sipe 82 comprises a central portion 84 and first and second portions of elongation 86, 88, each first and second portion of elongation 86, 88 communicating with the central portion 84. Each elongate sipe 82 also comprises first and second blind ends 90, 92 and first and second dimensioning points 94, 96 arranged so as to define, on one side, the central portion 84 arranged between the first and second dimensioning points 94, 96 and, on the other side, each first and second portion of elongation 86, 88 arranged respectively between each first and second dimensioning point 94, 96 and each first and second blind end 90, 92. Each first and second dimensioning point 94, 96 is separate from each first and second blind end 90, 92, respectively.

The curvilinear length of each first and second portion of elongation 86, 88, i.e. the curvilinear length between each first and second dimensioning point 94, 96 and each first and second blind end 90, 92, respectively, is in this case equal to 8 mm. The curvilinear length of the central portion 84, i.e. the curvilinear length between each first and second dimensioning point 94, 96, is in this case equal to 30 mm. As a result, the ratio between the curvilinear length of each first and second portion of elongation 86, 88 and the curvilinear length of the central portion 84 is strictly less than 1.0, preferably less than or equal to 0.7, preferably 0.5 and greater than or equal to 0.1, preferably 0.2 and more preferably ranges from 0.2 to 0.5, and in this case is equal to 0.27.

With reference to FIG. 5, the first and second dimensioning points 94, 96 define a direction of slenderness Ei of the elongate sipe 82 and a maximum dimension Lmax of the elongate sipe 82 in the direction of slenderness Ei of the elongate sipe 82 and a maximum dimension Imax of the elongate sipe 82 in a direction Epi perpendicular to the direction of slenderness Ei. In general, it should be noted that the direction of slenderness Ei of the elongate sipe 82 coincides with the direction of slenderness of the central portion 84. Each first and second portion of elongation 86, 88 extends in a direction of elongation Ea1, Ea2. In this case, Lmax=31 mm, Imax=10 mm such that the elongate sipe 82 has a slenderness ratio greater than or equal to 1.5, preferably 1.7 and more preferably 2.0, and in this case equal to 3.1.

Each direction of elongation Ea1, Ea2 of each first and second portion of elongation 86, 88 and the direction of slenderness Ei of the elongate sipe 82 form an angle less than or equal to 80°, preferably ranging from 30° to 70°, more preferably ranging from 30° to 50°, and in this case equal to 37°.

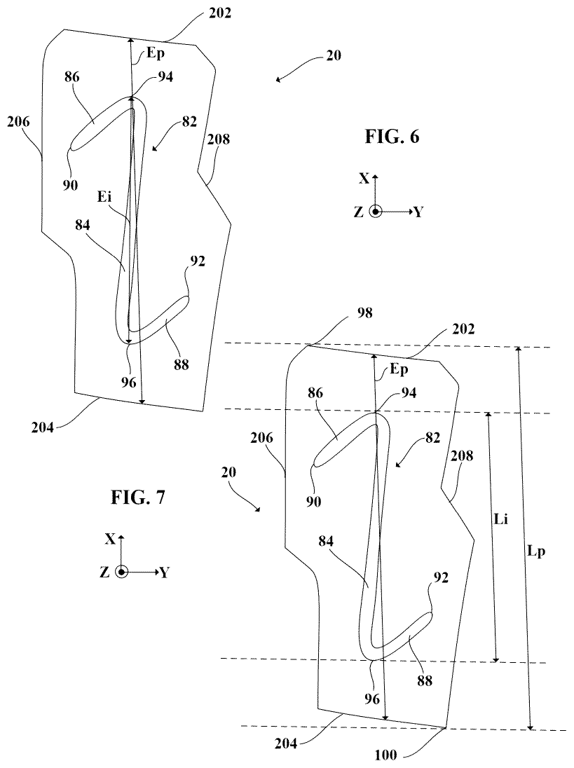

With reference to FIG. 6, the mean direction of slenderness Ep of the block 20 and the direction of slenderness Ei of the elongate sipe 82 form an angle less than or equal to 45°, preferably 30°, more preferably 15°, and more preferably still 5°.

With reference to FIG. 7, the distance Li between the first and second dimensioning points 94, 96 for dimensioning the elongate sipe 82 in the mean direction of slenderness Ep of the block 20 is in this case equal to 31 mm and the distance Lp between first and second dimensioning points 98, 100 for dimensioning the block 20 in the mean direction of slenderness Ep of the block 20 is in this case equal to 41 mm. The ratio between Li and Lp is greater than or equal to 0.5, preferably 0.7, and in this case is equal to 0.76.

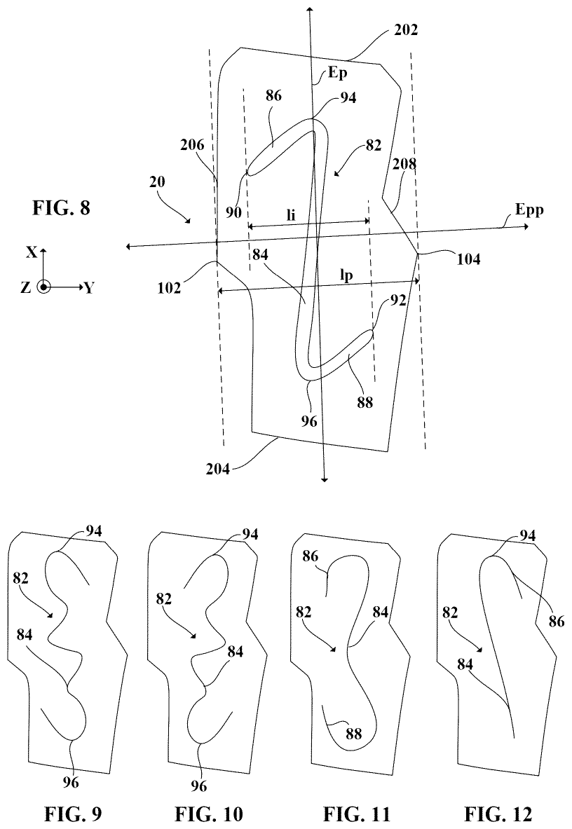

With reference to FIG. 8, the elongate sipe 82 has first and second dimensioning points for dimensioning the elongate sipe 82 in a direction Epp perpendicular to the mean direction of slenderness Ep of the block 20. In this case, each first and second dimensioning point for dimensioning the elongate sipe 82 in the direction Epp coincides with each first and second blind end 90, 92, respectively. The distance li between the first and second dimensioning points 90, 92 for dimensioning the elongate sipe 82 in the direction Epp is equal to 11 mm. The block 20 has first and second dimensioning points 102, 104 for dimensioning the block 20 in the direction Epp. The distance Ip between the first and second dimensioning points 102, 104 for dimensioning the block 20 in the direction Epp is equal to 22 mm. The ratio between li and Ip is greater than or equal to 0.3, preferably 0.5, and in this case is equal to 0.5.

With reference to FIG. 5, the central portion 84 and each first and second portion of elongation 86, 88 are arranged such that, along the elongate sipe 82 from each first and second portion of elongation 86, 88 to the central portion 84, there is a change in direction with respect to the direction of slenderness Ei of the elongate sipe 82 with passage respectively through each first and second dimensioning point 94, 96 for dimensioning the elongate sipe 82.

The central portion 84 is arranged such that, along the elongate sipe 82 in the central portion 84 from the first dimensioning point 94 to the second dimensioning point 96, there is no change in direction with respect to the direction of slenderness Ei of the elongate sipe 82.

The first portion of elongation 86 is arranged such that, along the elongate sipe 82 in the first portion of elongation 86 from the first dimensioning point 94 to the first blind end 90, there is no change in direction with respect to the direction of slenderness Ei. Similarly, the second portion of elongation 88 is arranged such that, along the elongate sipe 82 in the second portion of elongation 88 from the second dimensioning point 96 defining the direction of slenderness Ei to the second blind end 92, there is no change in direction with respect to the direction of slenderness Ei.

Returning to FIG. 2, it will be noted that at least 20%, preferably at least 30%, and in this case 50% of the number of blocks of the tread comprise an elongate sipe 82, in this particular case the blocks 20 of the circumferential columns 22, 24 and 30. At least 50%, preferably 75% of the number of blocks have a circumferential slenderness, i.e. in this case at least 50%, preferably 75% of the number of blocks 20 of the circumferential columns 22, 24, 30 and 32 comprise an elongate sipe 82.

FIGS. 9 to 12 show blocks comprising elongate sipes 82 according to other embodiments.

By contrast to the elongate sipes 82 described with reference to the preceding figures, the elongate sipes 82 in FIGS. 9 and 10 are such that the central portion 84 is not rectilinear. However, like for the elongate sipes 82 described with reference to the preceding figures, along the elongate sipe 82 in the central portion 84 from the first dimensioning point 94 defining the direction of slenderness Ei to the second dimensioning point 96, there is no change in direction with respect to the direction of slenderness Ei.

By contrast to the elongate sipes 82 described with reference to the preceding figures, the first and second elongate portions 86, 88 are curved in the same direction.

By contrast to the elongate sipes 82 described with reference to the preceding figures, the elongate sipe 82 in FIG. 12 comprises a single portion of elongation 86.

The invention is not limited to the embodiments described above.

1.-15. (canceled)

16. A tire having an inner side and an outer side that are imposed when the tire is mounted on a vehicle, the tire comprising a tread that comprises first and second axial edges arranged on the inner side and outer side, respectively, the tread comprising a plurality of blocks and a plurality of grooves comprising:
at least first, second and third circumferential grooves arranged such that there is at least a first, second and third substantially circumferential line passing through in each first, second and third circumferential groove, respectively, and extending continuously around a circumference of the tire without intersecting any block of the plurality of blocks, each first, second and third substantially circumferential line having an axial width greater than or equal to 2 mm, each first, second and third circumferential groove being arranged in an axial portion of an axial width equal to at most 75% of the axial width of the tread and extending from the first axial edge;
at least first, second and third circumferential columns of blocks of the plurality of blocks;
transverse grooves extending continuously from the first axial edge to the second axial edge of the tread substantially parallel to one another, each transverse groove crossing each first, second and third circumferential groove; and
at least one additional circumferential column of blocks of the plurality of blocks, the at least one additional circumferential column being a circumferential column, from among the first, second and third circumferential columns of blocks and the at least one additional circumferential column that is axially closest to the second axial edge,
wherein each block of the plurality of blocks comprises a leading edge corner, the leading edge corner of each block of at least each first, second and third circumferential column of blocks has a mean direction forming an angle with a circumferential direction of the tire strictly greater than an angle formed with the circumferential direction of the tire by a mean direction of the leading edge corner of each block of the at least one additional circumferential column of blocks.

17. The tire according to claim 16, wherein, with each transverse groove extending axially in an axially variable main direction, an angle formed by the axially variable main direction of each transverse groove and the circumferential direction of the tire exhibits a non-zero monotonous variation between the first and second axial edges of the tread, or is constant over at least one axial portion between the first and second axial edges of the tread and exhibits a non-zero monotonous variation over at least one additional axial portion between the first and second axial edges of the tread.

18. The tire according to claim 16, wherein the first circumferential groove is a circumferential groove from among the first, second and third circumferential grooves that is axially closest to the first axial edge, the third circumferential groove is a circumferential groove from among the first, second and third circumferential grooves that is axially closest to the second axial edge, and the second circumferential groove is axially between the first circumferential groove and the third circumferential groove.

19. The tire according to claim 16, wherein the first circumferential column of blocks is a column of blocks from among the first, second and third circumferential columns of blocks that is axially closest to the first axial edge, the third circumferential column of blocks is a column of blocks from among the first, second and third circumferential columns of blocks that is axially closest to the second axial edge, and the second circumferential column of blocks is axially between the first circumferential column and the third circumferential column.

20. The tire according to claim 16, wherein each block of the first circumferential column is delimited axially by the first circumferential groove and the first axial edge,
wherein each block of the second circumferential column is delimited axially by the first and second circumferential grooves, and
wherein each block of the third circumferential column is delimited axially at least partially by the third circumferential groove.

21. The tire according to claim 16, wherein the tread further comprises a fourth circumferential column of blocks of the plurality of blocks that is axially between the second and the third circumferential column of blocks, the leading edge corner of each block of the fourth circumferential column of blocks having a mean direction which forms an angle strictly greater than the angle formed by the mean direction of the leading edge corner of each block of the at least one additional circumferential column of blocks.

22. The tire according to claim 21, wherein each block of the fourth circumferential column is delimited axially by the second and third circumferential grooves.

23. The tire according to claim 16, wherein each block of the at least one additional circumferential column of blocks is delimited by at least one oblique groove which crosses at least two circumferentially consecutive transverse grooves and is arranged such that there is no circumferential line extending continuously around a circumference of the tire and passing through the at least one oblique groove delimiting each block of the at least one additional circumferential column of blocks without intersecting the blocks of the at least one additional circumferential column of blocks.

24. The tire according to claim 16, wherein the tread comprises first and second additional circumferential columns of blocks of the plurality of blocks, each first and second additional circumferential column being axially closer to the second axial edge than the first, second and third circumferential columns of blocks,
the leading edge corner of each block of at least each first, second and third circumferential column of blocks has a mean direction forming an angle strictly greater than the angle formed by the mean direction of the leading edge corner of each block of each first and second additional circumferential column of blocks,
each block of the first additional circumferential column of blocks being axially delimited by two oblique grooves crossing two circumferentially consecutive transverse grooves,
each block of the second additional circumferential column of blocks being axially delimited by an oblique groove crossing two circumferentially consecutive transverse grooves and the second axial edge,
each block of each first and second additional circumferential column of blocks being arranged such that there is no circumferential line extending continuously around a circumference of the tire and passing through the at least one oblique groove delimiting each block of each first and second additional circumferential column of blocks without intersecting the blocks of the first and second additional circumferential column of blocks, respectively.

25. The tire according to claim 16, wherein each first and second circumferential column of blocks comprises a single block between two circumferentially consecutive transverse grooves.

26. The tire according to claim 16, wherein the third circumferential column of blocks comprises at least two blocks between two circumferentially consecutive transverse grooves.

27. The tire according to claim 16, wherein the leading edge corner of at least one portion of the blocks of the third circumferential column of blocks has a curvilinear length strictly greater than a curvilinear length of each lateral edge corner of the block.

28. A pair of a first tire and a second tire, the first tire and the second tire each being the tire according to claim 16, wherein the tread of the first tire is symmetrical to the tread of the second tire with respect to a plane of symmetry substantially perpendicular to an axis of rotation common to the first tire and the second tire.
